(19) United States
(12) Patent Application Publication
(10) Pub. No.: US 2014/0030632 A1
(43) Pub. Date: Jan. 30, 2014

(54) PROCESS FOR SURFACE CONDITIONING OF A PLATE OR SHEET OF STAINLESS STEEL AND APPLICATION OF A LAYER ONTO THE SURFACE, INTERCONNECT PLATE MADE BY THE PROCESS AND USE OF THE INTERCONNECT PLATE IN FUEL CELL STACKS

(71) Applicants: Jørgen Gutzon Larsen, Bagsværd (DK); Søren Cliver Klitholm, Soborg (DK); Niels Christiansen, Gentofte (DK)

(72) Inventors: Jørgen Gutzon Larsen, Bagsværd (DK); Søren Cliver Klitholm, Soborg (DK); Niels Christiansen, Gentofte (DK)

(73) Assignee: Topsoe Fuel Cell, Lyngby (DK)

(21) Appl. No.: 14/111,896

(22) PCT Filed: Apr. 17, 2012
(86) PCT No.: PCT/EP2012/001660

§ 371 Date: Oct. 15, 2013

(30) Foreign Application Priority Data
Apr. 20, 2011 (DK) PA 2011 00310

(51) Int. Cl. H01M 8/02

(52) U.S. Cl. CPC H01M 8/0202
USPC 429/507; 429/535

(57) ABSTRACT

A process for the conditioning of and applying a ceramic or other layer onto the surface of a sheet of stainless steel comprises the steps of (a) optionally annealing the steel plate or sheet in a protective gas atmosphere at an elevated temperature, (b) controlled etching of the surface of the sheet to produce a roughened surface and (c) depositing a protective and electrically conductive layer onto the roughened metallic surface. The process leads to coated metallic sheets with desirable properties, primarily to be used as interconnects in solid oxide fuel cells and solid oxide electrolysis cells.

### TECHNICAL FIELD

The present invention relates to a process for surface conditioning of a plate or a sheet of stainless steel and subsequent application of a layer onto the surface. The invention further concerns an interconnect (IC) plate made by the process and the use of said interconnect plate in fuel cell stacks.

More specifically, the process of the invention is intended to be used in connection with the production of interconnect plates for a high temperature fuel cell, in particular a solid oxide fuel cell (SOFC) or a solid oxide electrolyser cell (SOEC), but also other high temperature fuel cells, such as a molten carbonate fuel cell (MCFC).

### BACKGROUND ART

In the following the invention will be described in relation to a solid oxide fuel cell (SOFC) or a solid oxide electrolyser cell (SOEC), which is a solid oxide fuel cell set in regenerative mode for the electrolysis of water with a solid oxide electrolyte to produce oxygen and hydrogen gas. The solid oxide fuel cell comprises a solid electrolyte that enables the conduction of oxygen ions, a cathode where oxygen is reduced to oxygen ions and an anode where hydrogen is oxidised. The overall reaction in an SOFC is that hydrogen and oxygen react electrochemically to produce electricity, heat and water. In order to produce the requisite hydrogen, the anode normally possesses catalytic activity for the steam reforming of hydrocarbons, particularly natural gas, whereby hydrogen, carbon monoxide and carbon dioxide are generated. Steam reforming of methane, the main component of natural gas, can be described by the following equations:

CH₄+H₂O→CO+3H₂

CH₄+CO₂→2CO+2H₂

CO+H₂O→CO₂+H₂

During operation an oxidant, such as air, is supplied to the solid oxide fuel cell in the cathode region. Fuel, such as hydrogen, is supplied in the anode region of the fuel cell. Alternatively, a hydrocarbon fuel, such as methane, is supplied in the anode region, where it is converted to hydrogen and carbon oxides through the above reactions. Hydrogen passes through the porous anode and reacts at the anode/electrolyte interface with oxygen ions generated on the cathode side that have diffused through the electrolyte. Oxygen ions are created at the cathode side with an input of electrons from the external electrical circuit of the cell.

In order to increase the voltage, several individual cells (cell units) are assembled to form a cell stack, and they are linked together by interconnects. An interconnect serves as a gas barrier to separate the anode (fuel) and cathode (air/oxygen) sides of adjacent cell units, and at the same time it enables current conduction between adjacent cells, i.e. between an anode of one cell unit with a surplus of electrons and a cathode of a neighbouring cell unit in need of electrons for the reduction process.

Interconnects are normally provided with a plurality of flow paths for the passage of fuel gas on one side of the interconnect and oxidant gas on the opposite side. To optimize the performance of an SOFC stack, a range of positive factors should be maximized without unacceptable consequences on another range of related negative factors, which should be minimized. Among the factors to be maximized are fuel utilization, electrical efficiency and life time, whereas factors to be minimized are production price, dimensions, production time, failure rate and the number of components.

The interconnect has a direct influence on most of the factors mentioned. Therefore, both the configuration and the characteristics of the interconnect are of considerable importance to the function of the cell stack.

It is often desirable to provide the interconnect with a protective coating in order to improve the characteristics of the interconnect. Such coatings may be applied by methods such as wash coating, screen printing, wet powder spraying, flame spraying or plasma spraying. When a protective coating is to be applied onto the surface of the metallic interconnect, said surface must have a roughness Rz of at least 3-5 μm to give a strong adherence between the coating and the interconnect plate, thereby binding the coating properly. However, pressed thin sheets or bands of stainless steel to be used as interconnects generally have a low surface roughness Rz of 3 μm or less, which makes it difficult to provide the interconnects with the requisite protective coating. Sand blasting is an efficient way to solve this problem, but thin steel bands, i.e. bands with a thickness of about 1 mm or below, will deform, making the use of the interconnect impossible. Of course, steel bands may be produced according to the intended use, i.e. they may be produced with a certain specific roughness, but the subsequent shaping of the steel band may spoil this roughness, at least to some extent.

It has now surprisingly been found that a surface conditioning comprising a controlled etching (flash etching) of shaped interconnect plates or sheets by using a wet chemical method, such as a wet chemical method involving a solution of FeCl₃ and HCl plus optionally a fluoride, may result in the formation of a surface with irregular, steep-sided blind holes, i.e. closed or “non-through” holes, due to selective etching of grains with a certain crystal lattice orientation, giving the surface a desired roughness Rz of between 3 μm and 50 μm. This roughened surface will form a strong bond to the coating when said coating is deposited on the surface.

In addition the etching lowers the concentration of elements which may be concentrated in or close to the surface, e.g. elements like Mn, Si, Ti and Al. Such elements are generally concentrated in the surface during the heat treatment of an alloy.

It is known that it is possible to influence or change the surface characteristics of metal items, such as plates or sheets of stainless steel, by etching the surface. For example, US 2010/0132842 A1 discloses a method for improving the surface properties of a specific stainless steel for bipolar plates of polymer electrolyte membrane fuel cells ensuring low interfacial contact resistance and good corrosion resistance at the same time. Said method comprises pickling the stainless steel with an aqueous sulphuric acid solution, washing the stainless steel with water, immersing it in a mixture solution of nitric acid and hydrofluoric acid to form a passivation layer and plasma-nitriding the immersed stainless steel to form a nitride layer on the surface of the stainless steel.

This known method is restricted to a specific steel type and a specified acid pickling with H₂SO₄ followed by an equally specified nitriding process to provide a nitride layer comprising CrN and/or Cr₂N on the steel surface. While this approach may be useful for a specific purpose, it does not extend to any broader range of utilities, and the cited patent application does not envisage the possibility of applying different kinds of coatings onto the steel surface by varying the etching and coating conditions. Moreover, the description of the cited reference is silent as to the importance of obtaining specially selected hole configurations on the steel surface.

JP 4491363 B2 describes an apparatus for plasma etching and other plasma processes, which apparatus i.a. may be used to form a thin film on a thin metal plate in the preparation of separators for fuel cells.

Etching in connection with the production of interconnects for fuel cells is also described in US 2003/0064269 A1, where a non-planar interconnect can be formed from a planar blank plate by machining or chemical etching. Here the purpose is to provide pins on the plate, said pins extending towards and contacting both anode and cathode, whereas the purpose according to the present invention is to impart a controlled degree of roughness to the surface of the metal plate, thereby enabling an adherent coating of the surface.

JP 4093321 B2 discloses a mixed-type porous tubular structure, e.g. a furnace core tube used to manufacture a solid oxide fuel cell, which is able to withstand a high temperature of 900° C. or more without risk of damage, such as cracking due to temperature cycles. A porous ceramic flame-spraying film is formed on a porous alloy-film by a plasma spraying process. Furthermore, a base material is etched by a wet etching method. Both the purpose and the means to achieve it are however quite different from those of the present invention.

Finally, US 2007/0248867 describes an etched interconnect for fuel cell elements comprising a solid oxide electrolyte, an anode and a cathode, where the interconnect includes a conductive base sheet having first and second faces with anode and cathode gas flow passages, respectively. In a preferred embodiment the gas flow passages are prepared using a photochemical etching process, but there are no references in regard to applying a coating on the surface of the interconnect.

### BRIEF DESCRIPTION OF THE INVENTION

As indicated above, the invention relates to a process for applying a layer, for example a ceramic or metallic layer onto a plate or a sheet of stainless steel, where the surface of the steel plate or sheet, prior to the application of a layer thereon, is roughened by etching to improve the bonding of the layer to the steel surface. The invention further relates to an interconnect plate made by the process and the use of said interconnect plate in fuel cell stacks.

### DETAILED DESCRIPTION OF THE INVENTION

More specifically the invention concerns a process for conditioning the surface of a plate or sheet of stainless steel with a thickness of from 0.2 mm up to 8 mm and subsequently applying a layer, such as a ceramic or metallic layer, onto said conditioned surface by wash coating, screen printing, wet powder spraying, flame spraying or plasma spraying, said process comprising the following steps:
a) optionally annealing the steel plate or sheet for up to 100 hrs in a protective gas atmosphere at a temperature of 600-1000° C. in order to segregate Si, Al, Ti and other oxidizable (electropositive) elements out in the surface,
b) controlled etching of the surface of the plate or sheet to produce a roughened surface with blind holes, i.e. closed or non-through holes, giving the surface a roughness Rz of between 3 μm and 50 μm and
c) depositing a protective and electrically conductive layer onto the roughened metallic surface, thereby forming a layer on the surface.

The protective and electrically conductive layer may be deposited onto the roughened metallic surface by thermal spraying, wash coating, screen printing, wet powder spraying, flame spraying, plasma spraying or any other suitable method. Other suitable methods include PVD (physical vapour deposition), CVD (chemical vapour deposition) and the use of galvanic processes.

Thus, the idea underlying the present invention is that an improved performance can be obtained using a fuel cell stack, in which the interconnects of the individual cells are made by the process of the present invention, said process consisting of a conditioning pre-treatment of the steel surface followed by a thermal spraying of a ceramic layer onto the conditioned surface.

The conditioning pre-treatment consists of an optional annealing of the surface of a steel plate or sheet for up to 100 hrs in a protective gas atmosphere at a temperature of 600-1000° C. followed by a controlled etching of said optionally annealed surface to obtain a roughened surface, which is optimally receptive for the ceramic layer to be applied.

The reason why it is preferred to conduct a preliminary heat treatment of the steel plate or sheet lies in the fact that the steel almost inevitably contains elements of Si, Ti and Al, which will concentrate at or close to the steel surface during operation at high temperature in an SOFC stack or by a suitable heat treatment. In both cases the electrical conductivity of the surface will decrease.

In a preferred embodiment the protective and electrically conductive ceramic powder layer deposited in step c) of the process is composed of LSM (lanthanum strontium manganite), La—Sr—Cr—O, La—Ni—Fe—O, La—Sr—Co—O, Co—Mn—Ni—O or La—Sr—Fe—Co—O.

The method of spraying is preferably selected from thermal plasma coating methods. It is especially preferred that the thermal plasma coating is carried out at or above the melting temperature of the applied powder.

The controlled etching can be carried out by using a wet chemical or other etching methods. Among the wet chemical methods preference is given to methods involving FeCl₃+HCl. It is furthermore preferred to carry out the controlled etching by using a wet chemical method involving a solution of FeCl₃ and HCl optionally containing a fluoride.

The etching may be followed by oxidation in air at a temperature of 800-950° C. for 1-10 hrs before coating.

The stainless steel may be selected from steel types with proper high-temperature corrosion resistance whether ferritic, austenitic, duplex or chromium or nickel based alloys. Preferably the steel is a ferritic stainless steel. Suitable ferritic stainless steels are Crofer® 22 H and Crofer® 22 APU from Thyssen Krupp, Sanergy™ HT from Sandvik AB and ZMG 232 types from Hitachi Metals Ltd. Those steels are particularly well suited for the purpose of the present invention which, however, is not restricted to these specific steels.

By using etching instead of other surface treatment methods it is possible to obtain a metallic surface with a reduced concentration of Si, Ti, Al, Mn and possibly other oxygenophilic elements which (except Mn) tend to reduce the electric conductivity of the surface leading to a lowering of the contact resistance.

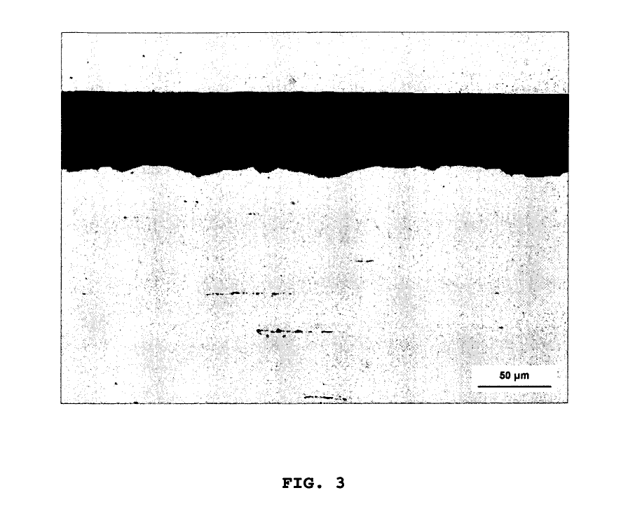

When etched and subsequently coated interconnects are used in fuel cell stacks, a markedly improved stack performance is observed as seen in FIG. 3. Furthermore, the corrosion of the fuel cell stack is likely to proceed more slowly.

The invention will now be further illustrated by the following examples.

### EXAMPLE 1

This example illustrates the etching of thin steel bands by the process according to the invention, especially focusing on the importance of the acid concentration.

Etching is a desirable approach to obtain the necessary roughness on the surface of a thin plate or band of steel, because sand blasting of thin steel bands, i.e. bands with a thickness below 1 mm, have a tendency to make the bands go out of shape, thus making the use of the interconnect impossible.

A number of etching experiments have been performed on Crofer® 22 APU steel plates to investigate how the depth of the etching is influenced by etching time and acid concentration. It was attempted to etch with care, thereby obtaining etchings that were not too deep.

The results obtained are presented in Table 1 below.

TABLE 1

Rz μm

| | | | |
|---|---|---|---|
| Plate data | position 1 | position 2 | position 3 |

| | | | | |
|---|---|---|---|---|
| 5-7 | μm* | 36.2 | 31.8 | 27.7 |
| 11 | μm* | 24.1 | 26.0 | 24.3 |
| 18 | μm* | 26.2 | 30.7 | 27.9 |
| 20 | μm* | 26.2 | 27.4 | 26.0 |

| | | | |
|---|---|---|---|
| Oxidised 1x | 1.49 | 1.59 | 1.76 |
| Crofer ® 22 APU | 2.00 | | |
| Oxidised 2x | 1.38 | 1.48 | 1.89 |
| Crofer ® 22 APU | 1.90 | | |

*removed steel from both sides based on weight loss

The etching was performed using a wet chemical method involving a solution of FeCl₃ with 0-1.5 wt % HCl.

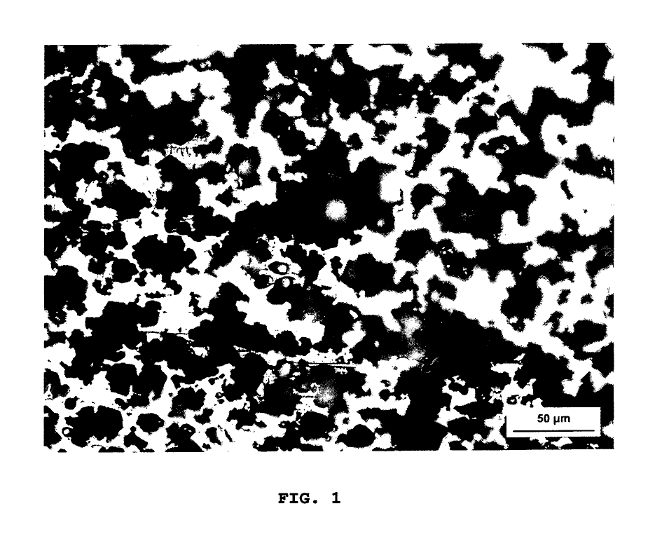

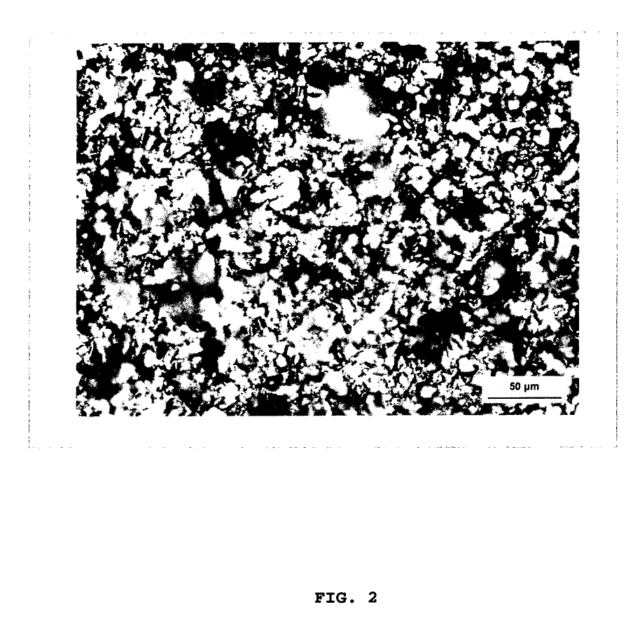

The above results show that the etching proceeded deep down (Rz=27.7-36.2 μm) into the plate where only 5-7 μm of the surface should have been removed. In this instance the reason is that approximately 40% of the original surface is still retained (see FIG. 1; etching depth 5-7 μm). This may be due to selective etching of grains with a certain crystal lattice orientation and/or to the presence of an inpersistent layer of protective chromium oxide at the surface, allowing the etching to proceed deeper down in the unprotected sites for the same amount of removed material. As it can be seen, the surface roughness is lower on the samples that have been etched deeper (FIG. 2; etching depth 11-20 μm). It is evident that the plasma coating will be able to bond to these surfaces.

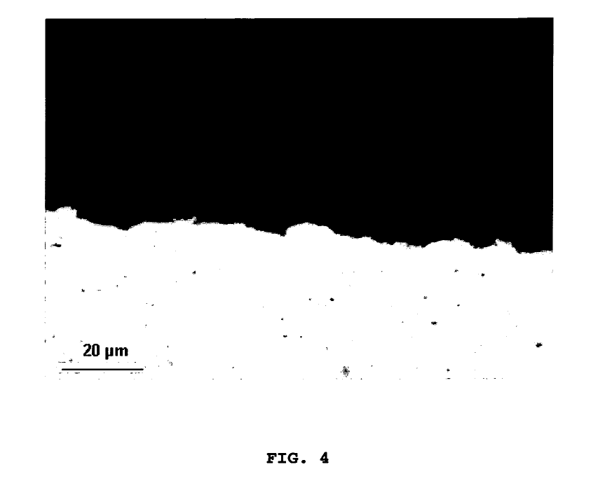

FIG. 3 is a microphotograph of an IC-plate, which has first been etched with FeCl₃+HCl and then coated with LSM (lanthanum strontium manganite). A close-up of the same microphotograph is shown on FIG. 4.

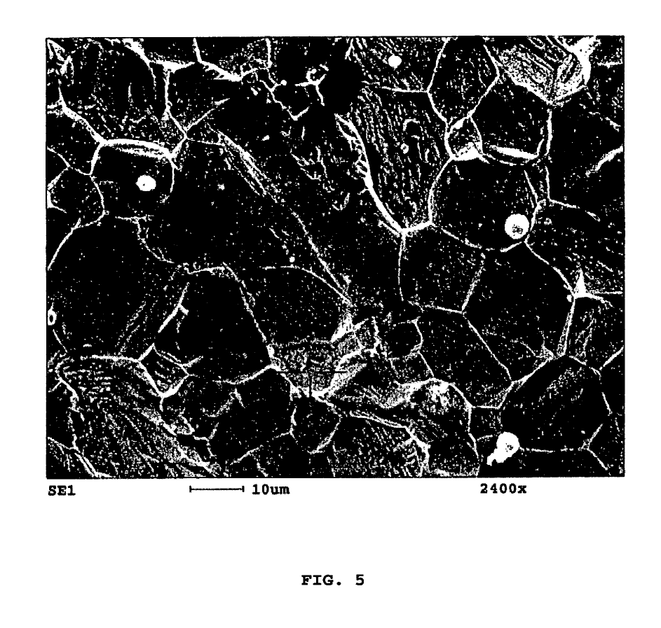

Another photograph, recorded with a scanning electron microscope (SEM), is shown on FIG. 5. The image shows a roughened surface formed by flash etching of the ferritic stainless steel Crofer® 22 APU.

### EXAMPLE 2

The performance of fuel cell stacks made of fuel cells with interconnect plates, which have been prepared by the process according to the invention, is measured and compared to the performance of similar fuel cell stacks made of fuel cells with interconnect plates prepared by a previous IC-pretreatment method at Topsoe Fuel Cell A/S.

By the etching treatment performed according to the invention the amount of Si is reduced in the surface. Each of the amounts of Ti and Al is reduced by a factor 5-10 times by the treatment.

The results of the observed performance of the two types of fuel cell stacks are presented in Table 2 (previous IC-pretreatment method) and Table 3 (process according to the invention) below.

TABLE 2
Average cell voltage (previous IC-pretreatment method)

| Measurement No. | Average cell voltage |
|---|---|
| 1 | 0.880 |
| 2 | 0.850 |
| 3 | 0.855 |
| 4 | 0.840 |
| 5 | 0.830 |
| 6 | 0.845 |
| 7 | 0.815 |
| 8 | 0.850 |
| 9 | 0.855 |
| 10 | 0.830 |
| 11 | 0.810 |
| 12 | 0.830 |
| 13 | 0.810 |
| 14 | 0.830 |
| 15 | 0.820 |
| 16 | 0.775 |
| 17 | 0.770 |
| 18 | 0.780 |
| 19 | 0.790 |
| 20 | 0.770 |
| 21 | 0.780 |
| 22 | 0.775 |

TABLE 3
Average cell voltage (process according to the invention)

| Measurement No. | Average cell voltage |
|---|---|
| 1 | 0.910 |
| 2 | 0.900 |
| 3 | 0.905 |
| 4 | 0.900 |
| 5 | 0.895 |
| 6 | 0.900 |
| 7 | 0.895 |
| 8 | 0.900 |
| 9 | 0.910 |
| 10 | 0.890 |
| 11 | 0.880 |
| 12 | 0.935 |
| 13 | 0.935 |
| 14 | 0.930 |
| 15 | 0.920 |
| 16 | 0.925 |
| 17 | 0.915 |
| 18 | 0.925 |

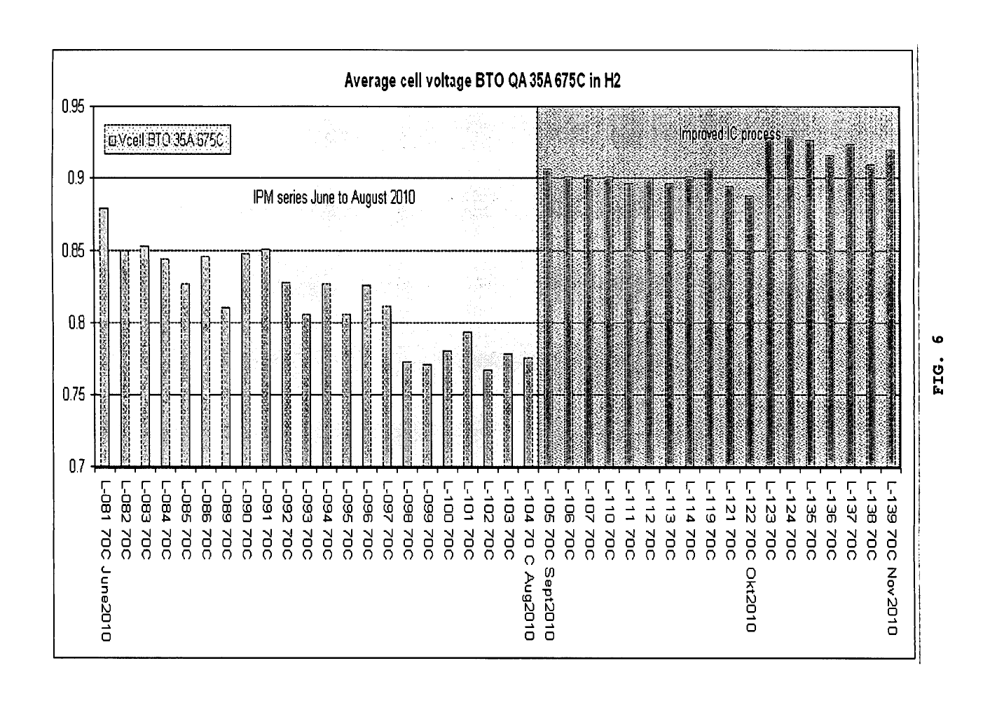

FIG. 6 is an illustration of the observed performance of the two types of fuel cell stacks described above. The left side part of the figure shows the performance of the stack made of fuel cells with interconnect plates prepared by a previous IC-pretreatment method, whereas the right side part of the figure shows the performance of the stack made of fuel cells with interconnect plates, which have been prepared by the process according to the invention. The Figure shows the average cell voltage measured over a period of about two months, and it clearly appears from the figure that the cell voltage at 35 A remains fairly constant (around 0.9 V) in cells with interconnects prepared according to the invention, whereas the cell voltage at 35 A in cells with interconnect plates, which have been prepared by the previous IC-pretreatment method, measured under identical conditions display a steady decrease from around 0.88 V to around 0.78 V over the measurement period.

1. A process for conditioning the surface of a plate or sheet of stainless steel with a thickness of from 0.2 mm up to 8 mm and subsequently applying a layer, such as a ceramic or metallic layer, onto said conditioned surface by wash coating, screen printing, wet powder spraying, flame spraying or plasma spraying, said process comprising the following steps:
a) optionally annealing the steel plate or sheet for up to 100 hrs in a protective gas atmosphere at a temperature of 600-1000° C. in order to segregate Si, Al, Ti and other oxidizable (electropositive) elements out in the surface,
b) controlled etching of the surface of the plate or sheet to produce a roughened surface with blind holes, i.e. closed or non-through holes, giving the surface a roughness Rz of between 3 μm and 50 μm and
c) depositing a protective and electrically conductive layer onto the roughened metallic surface, thereby forming a metallic oxide layer on the surface.

2. The process according to claim 1, wherein the optional annealing in step (a) is conducted for 1 hr or more in a protective gas atmosphere selected from Ar and other inert gases, N₂ and H₂.

3. The process according to any one of claims 1-2, wherein the layer to be applied in step (c) is a ceramic or metallic layer.

4. The process according to any one of claims 1-3, wherein the protective and electrically conductive layer is deposited onto the roughened metallic surface by thermal spraying, wash coating, screen printing, wet powder spraying, flame spraying, plasma spraying, PVD (physical vapour deposition), CVD (chemical vapour deposition) and galvanic processes.

5. The process according to any one of claims 1-4, wherein the layer deposited in step (c) is composed of LSM (lanthanum strontium manganite), La—Sr—Cr—O, La—Ni—Fe—O, La—Sr—Co—O, Co—Mn—Ni—O or La—Sr—Fe—Co—O or consists of a perovskite material having the general formula ABO₃ or a spinel material having the general formula ABO₄ in which the elements A and B generally have oxidation states +2 and +3.

6. The process according to any one of claims 1-4, wherein the coating applied in step (c) consists of Co or a combination of Co and Ni formed by PVD (physical vapour deposition), CVD (chemical vapour deposition) or a galvanic process.

7. The process according to any one of claims 1-4, wherein the metallic layer is selected from high temperature oxidation resistant alloys.

8. The process according to any one of claims 1-7, wherein the controlled etching in step (b) is carried out by using wet chemical or other etching methods.

9. The process according to any one of claims 1-8, wherein the thermal spraying is a plasma spraying process carried out at a temperature where the coating powder is completely or predominantly melted.

10. The process according to claim 8, wherein the etching is carried out by using a wet chemical method involving FeCl₃ and HCl.

11. The process according to any one of claim 8 or 10, wherein the controlled etching is carried out by using a wet chemical method involving FeCl₃, HCl, HNO₃, NH₄F or combinations thereof.

12. The process according to any one of claims 1-11, wherein the etching is followed by oxidation in air at a temperature of 800-950° C. for 1-10 hrs before coating.

13. The process according to any one of claims 1-12, wherein the stainless steel is a high-temperature ferritic stainless steel.

14. The process according to claim 13, wherein the stainless steel is selected from Crofer® 22 H, Crofer® 22 APU, Sandvik Sanergy™ HT, ZMG 232L, ZMG J3 and ZMG G10.

15. The process according to any one of claims 1-14, wherein the metal sheets prior to the etching are heat treated in a low O₂ containing atmosphere of H₂, Ar or the like at a temperature of 600-1200° C. for 0-100 hrs in order to concentrate Si, Ti and Al close to or on the surface.

16. A plate prepared by coating of a sheet of stainless steel using the process according to any one of claims 1-15.

17. An interconnect plate (IC-plate) prepared by coating of a thin sheet of stainless steel using the process according to any one of claims 1-15.

18. Use of the interconnect plate (IC-plate) according to claim 17 in a solid oxide fuel cell (SOFC) stack or a solid oxide electrolysis cell (SOEC) stack.

19. High temperature fuel cell stack comprising a plurality of interconnect plates (IC-plates) according to claim 16.
